(19) United States
(12) Patent Application Publication
(10) Pub. No.: US 2020/0183803 A1
(43) Pub. Date: Jun. 11, 2020

(54) System For Completely Testing Communication Links Inside Processor According To Processor Information And Method Thereof

(71) Applicants: Inventec (Pudong) Technology Corporation, Shanghai (CN); Inventec Corporation, Taipei City (TW)

(72) Inventor: Yan Li, Shanghai (CN)

(21) Appl. No.: 16/228,417

(22) Filed: Dec. 20, 2018

(30) Foreign Application Priority Data
Dec. 11, 2018 (CN) 201811508792.8

(51) Int. Cl. G06F 11/22

(52) U.S. Cl. CPC G06F 11/2242

(57) ABSTRACT

A system for completely testing communication links inside a processor according to processor information and a method thereof are provided. By the technical means of configuring each thread corresponding to each node for each processing core according to processor information and component information after obtaining the processor information of a processor on a motherboard and the component information of an external component; using each processing core to execute the each thread to access the external component through the node, which corresponds to the executed thread and is connected to the external component, to generate an access result; and determining whether the access result is correct or not, the system and the method can test the stability between the processor and other components of a computing device and achieve the technical effect of improving the effectiveness of the test.

### BACKGROUND OF THE INVENTION

### 1. Field of the Invention

The present invention relates to a system for testing and a method thereof. In particular, the invention pertains to a system for completely testing communication links inside a processor according to processor information and a method thereof.

### 2. Description of the Related Art

In order to confirm the performance and stability of computing devices such as servers, computing devices are typically required to be tested during the production of computing devices. The current method usually performs parallel stress tests, such as scanning each bit of the memory, reading and writing each bit in the hard disk, and sending and receiving a large number of packets for a period of time, on various components of a computing device, such as a processor, a memory module, a hard disk, and a network card, so as to completely cover all components.

However, in the above test method, in fact, only the components themselves are tested to ensure the stability of the components during the operation of the computing device, but it does not ensure the stability performance between components and a processor under specific conditions. For example, if a processing core in the processor accesses the specific component, an abnormal condition occurs. In the above stress tests, the processor randomly assigns the items tested by the processing core in the processor, so that in the testing process, it may happen that the processing core has no access to the specific component that causes the anomalies. In this way, it is unable to find such a problem during the tests.

In summary, it can be seen that there is a problem in the prior art that there is no test on the stability between the processor and other components in the existing stress tests. Therefore, it is necessary to propose an improved technical solution to solve this problem.

### SUMMARY OF THE INVENTION

In view of the prior art, there is a problem that there is no test on the stability between a processor and other components of a computing device in the existing stress tests, and the present invention discloses a system for completely testing communication links inside a processor according to processor information and a method thereof.

The system for completely testing communication links inside the processor according to processor information disclosed in the present invention at least includes a processor information acquisition module, configured to obtain processor information of a processor on a motherboard, wherein the processor includes a plurality of processing cores and a plurality of nodes; a component information acquisition module, configured to obtain component information of at least one external component on the motherboard, wherein the at least one external component is connected to at least one of the plurality of nodes; a thread configuration module, configured to configure each thread corresponding to each of the plurality of nodes for each of the plurality of processing cores according to the processor information and the component information, so that each of the plurality of processing cores executes the each thread to access the at least one external component through the node, which corresponds to the executed thread and is connected to the at least one external component, to generate an access result; and a result determination module, configured to determine whether the access result is correct or not.

The method for completely testing communication links inside the processor according to processor information disclosed in the present invention includes the steps of: obtaining processor information of a processor on a motherboard, the processor comprising a plurality of processing cores and a plurality of nodes; obtaining component information of at least one external component on the motherboard, the at least one external component being connected to at least one of the plurality of nodes; configuring each thread corresponding to each of the plurality of nodes for each of the plurality of processing cores according to the processor information and the component information; using each of the plurality of processing cores to execute the each thread to access the at least one external component through the node, which corresponds to the executed thread and is connected to the at least one external component, to generate an access result; and determining whether the access result is correct or not.

The system and method disclosed by the present invention are as above, and the difference from the prior art is that configuring each thread corresponding to each node for each processing core according to processor information and component information after obtaining the processor information of a processor on a motherboard and the component information of an external component; using each processing core to execute the each thread to access the external component through the node, which corresponds to the executed thread and is connected to the external component, to generate an access result; and determining whether the access result is correct or not. Above-mentioned technical means can be used to solve the problems of the prior art, and to achieve the technical effect of improving the effectiveness of the test.

### BRIEF DESCRIPTION OF THE DRAWINGS

The structure, operating principle and effects of the present invention will be described in detail by way of various embodiments which are illustrated in the accompanying drawings.

FIG. 1 is a system architecture diagram of a system for completely testing communication links inside a processor according to processor information according to the present invention.

FIG. 2 is a schematic diagram of internal components of the processor of the present invention.

FIG. 3A is a flow chart of a method for completely testing communication links inside the processor according to processor information according to the present invention.

FIG. 3B is a flow chart of an additional method for completely testing communication links inside the processor according to processor information according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

As used herein, the term “or” includes any and all combinations of one or more of the associated listed items. It will be understood that when an element is referred to as being “on” “connected to” or “coupled to” another element, it can be directly on, connected or coupled to the other element, or intervening elements may be present. In contrast, when an element is referred to as being “directly on” “directly connected to” or “directly coupled to” another element, there are no intervening elements present.

In addition, unless explicitly described to the contrary, the word “comprise” and variations, such as “comprises” “comprising”, will be understood to imply the inclusion of stated elements but not the exclusion of any other elements.

In the present invention, the communication links between each processing core in a processor and each node in the processor of a computing device can be tested, so as to avoid the condition that most processing cores can correctly access nodes but some processing cores cannot access the same external components correctly due to abnormal communication links.

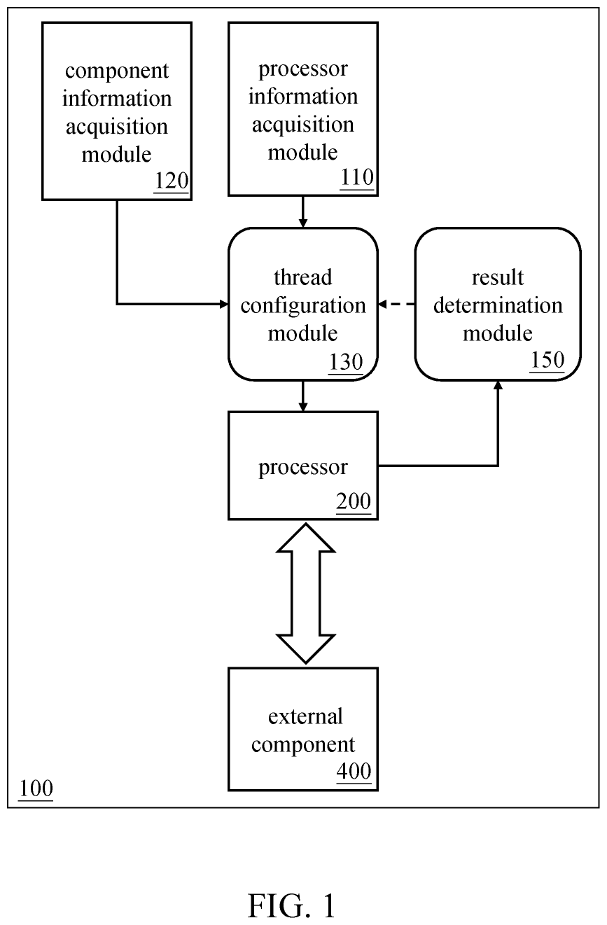

The operation of the system of the present invention will be described with reference to FIG. 1, and FIG. 1 is a system architecture diagram of a system for completely testing communication links inside a processor according to processor information according to the present invention. As shown in FIG. 1, the system for completely testing communication links inside a processor according to processor information of the present invention comprises a processor information acquisition module 110, a component information acquisition module 120, a thread configuration module 130, and a result determination module 150.

The processor information acquisition module 110 is responsible for obtaining processor information of the processor 200 of the computing device 100, wherein the processor 200 comprises a plurality of processing cores and a plurality of nodes. The processor information comprises the number of the processing cores in the processor 200, the communication links between each of the processing cores, the node information of each node included in the processor 200, and the connection relationship between each processing core and each node, but the invention is not limited thereto.

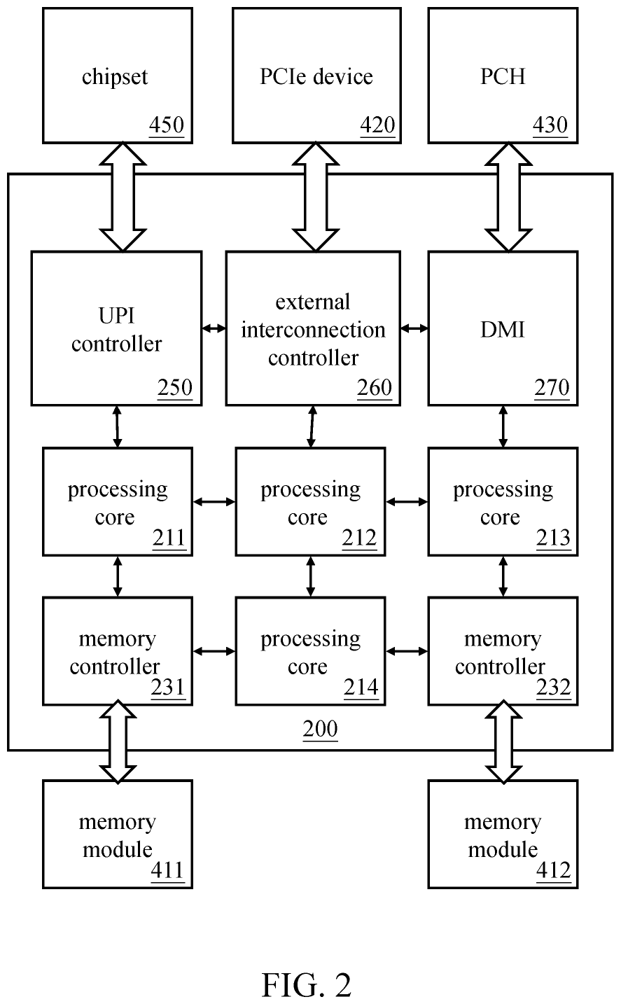

The node of the present invention is the external communication unit of the processor 200. As shown in FIG. 2, the nodes may be the memory controllers 231/232, the external interconnection controller 260, or may be the ultrapath interconnect (UPI) controller 250 and the direct media interface (DMI) 270, but the nodes mentioned in the present invention are not limited to the above. For example, the node may be the quickpath interconnect (QPI) controller. In addition, the number of the same type of node is not limited to one. For example, the processor 200 may also comprises two or more external interconnection controllers 260, and/or may comprise two or more UPI controllers 250.

The communication link of the present invention is a route for transferring data between any two processing cores included in the processor 200 or any processing core and node. As shown in FIG. 2, there is a directly connected communication link between the processing core 211 and the processing core 212, between the processing core 212 and the processing core 213, and between the processing core 212 and the processing core 214. There is a communication link indirectly connected through other processing core between the processing core 211 and the processing core 213, between the processing core 211 and the processing core 214, and between the processing core 213 and the processing core 214. In addition, the connection relationship between each processing core and each node of the present invention is that, for example, the processing core 211 is connected to the memory controller 231 and the UPI controllers 250, the processing core 212 is connected to the external interconnection controller 260, the processing core 213 is connected to the memory controller 232 and the DMI 270, and the processing core 214 is connected to the memory controllers 231/232.

In general, the processor information acquisition module 110 can detect the processor 200 through the power-on self-test (POST) of the computing device or load the extensible firmware interface (EFI) driver to identify the processor 200 to obtain the identification data of the processor 200, and then loads the corresponding processor information according to the identification data of the processor 200. However, the method in which the processor information acquisition module 110 obtains the processor information is not limited to the above.

The component information acquisition module 120 is responsible for obtaining the component information of the external components connected to the processor 200. The external components may be a memory module 411/412 connected to the memory controller 231/232, a peripheral component interconnect express (PCIe) device 420 connected to the external interconnection controller 260, various chipsets 450 connected to the UPI controllers 250, a platform controller hub (PCH) 430 connected to the DMI 270, and the like.

The component information acquisition module 120 can provide a user interface to set the component information of the external component. The component information acquisition module 120 can also can also obtain the component information of the external components through the detection of POST of the computing device or the identification of the EFI driver. However, the manner in which the component information acquisition module 120 obtains the component information of the external component is not limited to the above.

The thread configuration module 130 is configured to configure each thread corresponding to each node for each processing core in the processor 200 according to the processor information obtained by the processor information acquisition module 110, so that each processing core executes the threads respectively, the number of which and the number of the nodes included in processor 200 are the same, so as to access the external component 400 through the node, which corresponds to the executed thread and is connected to the external component 400, to generate an access result. The process where the processing core accesses the external component 400 of the present invention may be that the processing core reads data from the external component 400 or writes data to the external component 400, that the processing core transmits data to the external component 400 or receives data transmitted by the external component 400, etc., but the invention is not limited to the above. It should be particularly noted that the process where the processing core accesses the external component 400 is not limited to performing one operation, and may perform two or more types of operation. For example, the processing core can perform writing and reading operations or transmitting and receiving operations in one access process, and can even perform reading, transmitting, receiving and writing sequentially in one access process. Additionally, the access results of the present invention comprises any data related to the process where the processing core accesses the external component 400, which is not limited to the data transmitted, received, read, or written by the processing core.

In more detail, the thread configuration module 130 may configures corresponding threads according to the component information obtained by the information acquisition module 120, and the communication links between each of the plurality of processing cores and connection relationship between each of the plurality of nodes and each of the plurality of processing cores included in the processor information, so that each processing core can access the external component 400 through each node. For example, when the component information indicates that the external components are the memory modules 411/412, the thread configuration module 130 can configure the threads corresponding to the memory modules 411/412 to the processing core 211, so that the processing core 211 can read and write the memory modules 411/412 through the memory controllers 231/232 after executing the threads configured by the thread configuration module 130; when the component information indicates that the external components are the PCIe device 420, the PCH 430, and the chipset 450, the thread configuration module 130 can configure the corresponding threads for the processing core 211, so that the processing core 211 communicates with the PCIe device 420 through the external interconnection controller 260, communicates with the chipset 450 through the UPI controller 250, and communicates with the PCH 430 through the DMI 270 after executing the threads configured by the thread configuration module 130. Similarly, the thread configuration module 130 can also configure the threads corresponding to the external components, such as the memory modules 411/412, the PCIe device 420, the PCH 430, and the chipset 450, for the processing core 212, the process core 213 and the processing core 214 respectively, so that the processing core 212, the processing core 213, and the processing core 214 can read and write the memory modules 411/412 through the memory controllers 231/232, respectively, communicates with the PCIe device 420 through the external interconnection controller 260, communicates with the chipset 450 through the UPI controller 250, and communicates with the PCH 430 through the DMI 270.

In some embodiments, the thread configuration module 130 may further select one of the plurality of processing cores included in the processor 200 according to the communication links between each of the plurality of processing cores and connection relationship between each of the plurality of nodes and each of the plurality of processing cores included in the processor information obtained by the processing information acquisition module 110, and configure the thread, which is the same as the thread that other processing cores have executed, for the selected processing core, so that the selected processing core executes the thread, that is, transferring the same data to the same node, writing the same data to the same location in the same node, or reading the same data from the same location of the same node. The processing core selected by the thread configuration module 130 is a processing core directly connected to the node, that is, a processing core that can access the node without communication links with other processing cores.

The result determination module 150 is responsible for determining whether the access result generated by each processing core in the processor 200 is correct. For example, the result determination module 150 determines whether the response received by the processing core after transmitting the data is correct, or reads and determines whether the data written by the processing core to a specific location is correct.

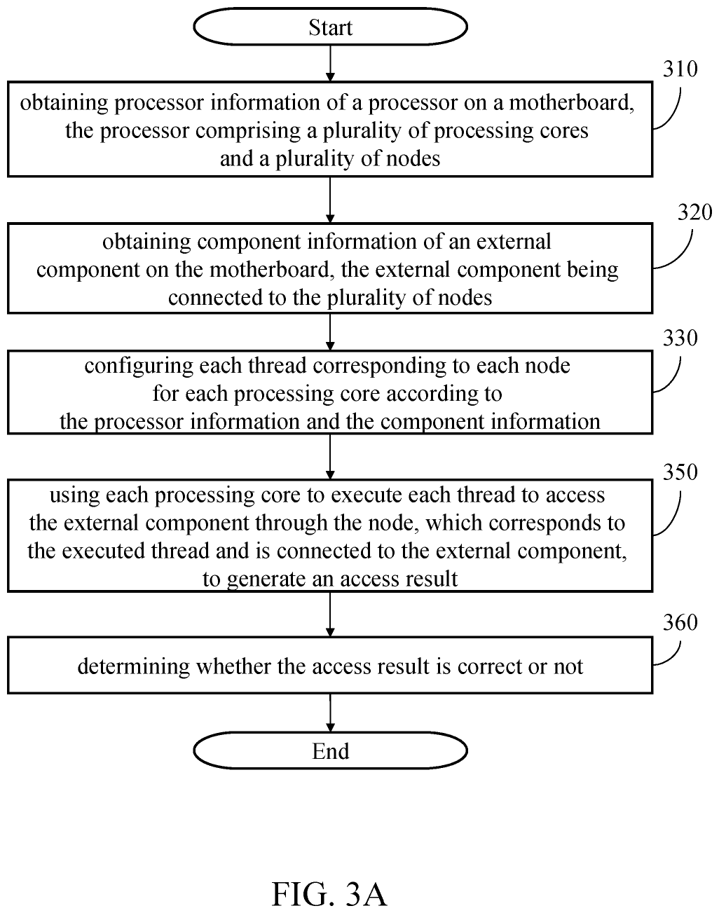

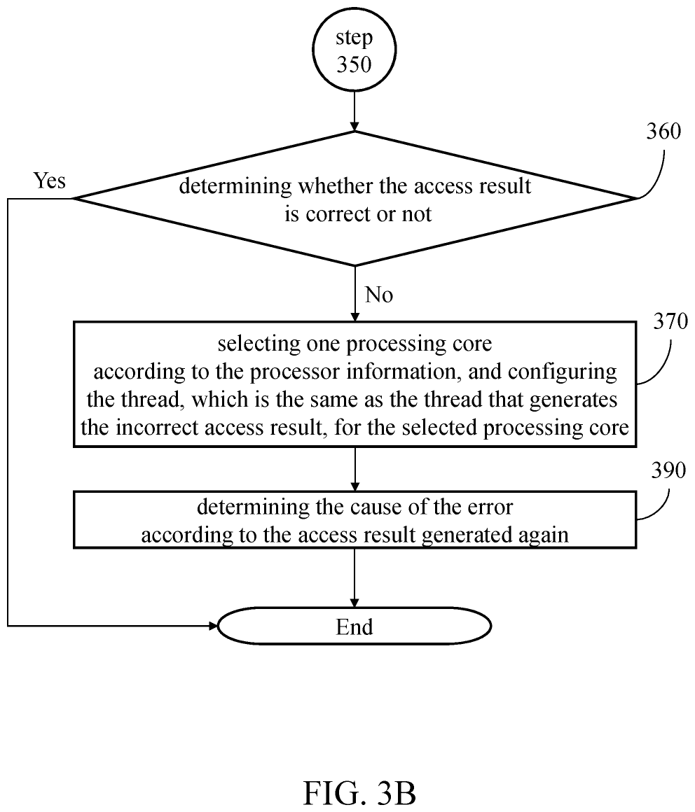

Next, an operational system and method of the present invention will be described with reference to an embodiment. Please refer to FIG. 3, which is a flowchart of a method for completely testing the communication links inside the processor according to the processor information. In this embodiment, it is assumed that the processor 200 (as shown in FIG. 2) on the motherboard of the computing device 100 to be tested comprises four processing cores (processing cores 211 to 214), two memory controllers, one UPI controller 250, one external interconnection controller 260, and one DMI 270, but the present invention is not limited thereto. For example, the processor 200 may comprise more than four processing cores, may only comprise one or more memory controllers, or may comprise two or more UPI controllers 250 and external interconnection controllers 260.

In the testing process of the present invention, firstly, the processor information acquisition module 110 can obtain the processor information of the processor 200 (step 310), and the component information acquisition module 120 can obtain the component information of the external component (step 320). In this embodiment, it is assumed that the processing information acquisition module 110 and the component information acquisition module 120 can obtain the processor information of the processor 200 and the component information of the external components connected to the nodes included in the processor 200 respectively by execute POST through the basic input/output system (BIOS) of the computing device 100 or through the data generated by loading the EFI driver.

It should be noted that, in the present invention, the processor information acquisition module 110 can obtain the processor information of the processor 200 (step 310) and the component information acquisition module 120 can obtain the component information of the external component (step 320). There is no prioritized relationship, that is, the component information acquisition module 120 can first obtain the component information of the external component (step 320), and then the processing information acquisition module 110 obtains the processor information of the processor 200 (step 310).

After the processing information acquisition module 110 obtains the processor information of the processor 200 (step 310) and the component information acquisition module 120 obtains the component information of the external component (step 320), the thread configuration module 130 can configure each thread corresponding to each node included in the processor 200 for each processing core included in the processor 200 according to the processor information obtained by the processor information acquisition module 110 and the component information obtained by the component information acquisition module 120 (step 330). In this embodiment, it is assumed that the thread configuration module 130 can configure each thread corresponding to each node included in the processor 200 for each processing core according to the communication links between each of the processing cores and the connection relationship between each node and each processing core included in the processor information, and the component information. In more detail, the processor 200 comprises five nodes, such as one memory controller 231, one memory controller 232, one UPI controller 250, one external interconnection controller 260, and one direct media interface 270, so that the thread configuration module 130 can configure the same number of threads as the number of nodes (that is, the number of threads is five) for each processing core (processing cores 211 to 214). That is, the thread configuration module 130 configures the thread that accesses the memory module 411 through the memory controller 231, configures the thread that accesses the memory module 412 through the memory controller 232, configures the thread that communicates with the chipset 450 through the UPI controller 250, configures the thread that communicates with PCIe device 420 through the external interconnection controller 260, and configures the thread that communicates with the PCH 430 through the DMI 270.

After the thread configuration module 130 configures each thread corresponding to each node included in the processor 200 for each processing core (processing cores 211 to 214) included in the processor 200 (step 330), each of the processing cores can frequently accesses external components 400 through the node, which corresponds to the executed thread and is connected to the external components 400, when executing the configured thread, so as to generate an access result (step 350). In this embodiment, each processing core (processing cores 211 to 214) can access the external components 400 such as the memory module 411, the memory module 412, the chipset 450, the PCIe device 420, and the PCH 430, which are connected to each node, through the nodes such as the memory controller 231, the memory controller 232, the UPI controller 250, the external interconnection controller 260, and the DMI 270, and the access results corresponding to each node can be generated after accessing.

After each processing core executes each configured thread and generates the access result, the result determination module 150 can determine whether the access result is correct (step 360), and can generate and output a result report. Thus, in the present invention, it is possible to completely test whether the communication link between each processing core and each node inside the processor 200 is correct or not.

In this embodiment, the method for completely testing communication links inside the processor according to the processor information can also comprises the flow as shown in FIG. 3B. When the result determination module 150 determines that the access result is incorrect, the thread configuration module 130 may select one processing core according to the processor information of the processor 200 obtained by the processor information acquisition module 110, and configure the thread, which is the same as the thread that generates the incorrect access result, for the selected processing core (step 370). In this embodiment, it is assumed that the result determination module 150 determines that the access result generated by the processing core 213 when accessing the memory module 411 through the memory controller 231 is incorrect, the thread configuration module 130 may select the processing core that is directly connected to the node corresponding to the incorrect access result generated. If the data transferring route between the processing core 213 and the memory controller 231 in the processor information comprises the communication link between the processing core 213 and the processing core 212, the communication link between the processing core 212 and the processing core 211, and the connection between the processing core 211 and the memory controller 231, the thread configuration module 130 can select the processing core 211 that is directly connected to the memory controller 231 according to the data transferring route between the processing core 213 and the memory controller 231, and configure the thread, which is the same as the thread that generated the incorrect access result in the processing core 213, for the selected processing core 211.

After the thread configuration module 130 configures the thread for the selected processing core again, the selected processing core (that is, the processing core with the configured thread) can execute the configured thread again, so as to access the external component 400 through the connected node, and generate an access result. The result determination module 150 can determine the cause of the error according to the newly generated access result (step 390). In this embodiment, the processing core 211 can perform the access operation, which is the same as the processing core 213 accesses the memory module 411, to the memory module 411 and generate a new access result. The result determination module 150 can determine whether there is an error occurred in the communication link between the processing core 213 and the processing core 211 or in the bus between the memory controller 231 and the memory module 411 (that is, the bus connecting the processor 200 and the external component 400) according to whether the new access result generated by the processing core 211 is correct. For example, when the new access result is still incorrect, it indicates that there is an error occurred in the bus between the memory controller 231 and the memory module 411; when the new access result is correct, it indicates that there is an error occurred in the communication link between the processing core 213 and the processing core 211.

In summary, it can be seen that the difference between the present invention and the prior art is that configuring each thread corresponding to each node for each processing core according to processor information and component information after obtaining the processor information of a processor on a motherboard and the component information of an external component; using each processing core to execute the each thread to access the external component through the node, which corresponds to the executed thread and is connected to the external component, to generate an access result; and determining whether the access result is correct or not. Above-mentioned technical means can be used to solve the problem of the prior art that there is no test on the stability between a processor and other components of a computing device in the existing stress tests, and to achieve the technical effect of improving the effectiveness of the test.

Furthermore, the method for completely testing communication links inside the processor according to processor information of the present invention may be implemented by hardware, software or a combination thereof, and may be implemented by centralized computer system or different devices distributed in interconnected computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method for completely testing communication links inside a processor according to processor information, comprising following steps:
obtaining processor information of a processor on a motherboard, the processor comprising a plurality of processing cores and a plurality of nodes;
obtaining component information of at least one external component on the motherboard, the at least one external component being connected to at least one of the plurality of nodes;
configuring each thread corresponding to each of the plurality of nodes for each of the plurality of processing cores according to the processor information and the component information;
using each of the plurality of processing cores to execute the each thread to access the at least one external component through the node, which corresponds to the executed thread and is connected to the at least one external component, to generate an access result; and
determining whether the access result is correct or not.

2. The method according to claim 1, wherein the step of obtaining the processor information of the processor on the motherboard is that detecting the processor to obtain the processor information.

3. The method according to claim 1, wherein the step of obtaining the component information of the at least one external component on the motherboard is that detecting the at least one external component to obtain the component information and/or providing for setting the component information.

4. The method according to claim 1, wherein the step of configuring each thread corresponding to each of the plurality of nodes for each of the plurality of processing cores according to the processor information and the component information is that configuring the each thread corresponding to each of the plurality of nodes for each of the plurality of processing cores according to the component information, and the communication links between each of the plurality of processing cores and connection relationship between each of the plurality of nodes and each of the plurality of processing cores included in the processor information.

5. The method according to claim 1, wherein the method further comprises following steps: when determining that the access result is incorrect, selecting one of the plurality of processing cores according to the processor information, configuring the thread, which is the same as the thread that generates the incorrect access result, for the selected processing core, and determining the cause of the error according to the access result generated by the selected processing core again.

6. A system for completely testing communication links inside a processor according to processor information, comprising:
a processor information acquisition module, configured to obtain processor information of a processor on a motherboard, wherein the processor comprises a plurality of processing cores and a plurality of nodes;
a component information acquisition module, configured to obtain component information of at least one external component on the motherboard, wherein the at least one external component is connected to at least one of the plurality of nodes;
a thread configuration module, configured to configure each thread corresponding to each of the plurality of nodes for each of the plurality of processing cores according to the processor information and the component information, so that each of the plurality of processing cores executes the each thread to access the at least one external component through the node, which corresponds to the executed thread and is connected to the at least one external component, to generate an access result; and
a result determination module, configured to determine whether the access result is correct or not.

7. The system according to claim 6, wherein the processor information acquisition module detects the processor to obtain the processor information.

8. The system according to claim 6, wherein the component information acquisition module detects the at least one external component to obtain the component information and/or provides setting of the component information.

9. The system according to claim 6, wherein the thread configuration module configures the each thread corresponding to each of the plurality of nodes for each of the plurality of processing cores according to the component information, and the communication links between each of the plurality of processing cores and connection relationship between each of the plurality of nodes and each of the plurality of processing cores included in the processor information.

10. The system according to claim 6, wherein the thread configuration module is further configured to select one of the plurality of processing cores according to the processor information when the result determination module determines that the access result is incorrect, and configure the thread, which is the same as the thread that generates the incorrect access result, for the selected processing core, and the result determination module is further configured to determine the cause of the error according to the access result generated by the selected processing core again.
